(19) United States
(12) Patent Application Publication
(10) Pub. No.: US 2008/0100845 A1
(43) Pub. Date: May 1, 2008

(54) Inline photometer device and calibration method

(75) Inventor: Richard Gerard Meyer, Mequon, WI (US)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Optek-Danulat GmbH

(21) Appl. No.: 11/588,633

(22) Filed: Oct. 27, 2006

(51) Int. Cl. G01N 21/03; G01N 21/00

(52) U.S. Cl. 356/440

(57) ABSTRACT

The invention relates to an inline photometer device having a light source (6), a photodetector (7) placed at a distance therefrom, a measurement cell (2) which is arranged in the beam path (8) between the light source (6) and the photodetector (7) and through which a fluid to be measured can flow, and having a calibration device (9) for calibrating and/or validating the inline photometer device (1), the calibration device (9) comprising holding means (10) for arranging a reference part in the beam path. According to the invention, the reference part (11) is filled or fillable with a reference fluid (12).

The invention relates to an inline photometer device according to the precharacterising clause of claim 1 and to a calibration device for an inline photometer device according to the precharacterising clause of claim 2, as well as to a calibration method for the measurement of a fluid by an inline photometer device.

Inline photometer devices are well known and are used in very many fields of technology, for example in the pharmaceutical industry, the chemical industry and in beverage and food production, in order to carry out photometric analyses of fluids directly—inline—during the production process. To this end, the measurement cell of inline photometer devices is integrated directly in a main pipeline or optionally a bypass line, or is formed thereby.

Inline photometers are equipped with a light source, for example for ultraviolet light (UV), visible light (VIS) and/or infrared light (NIR). The electromagnetic spectrum emitted by the light source passes through the measurement cell, through which a medium to be measured flows, and reaches a photodetector by which the intensity of a particular wavelength or a wavelength range of the incoming electromagnetic radiation can be measured. The measured intensity is inversely proportional to the absorption of the medium to be measured, which is in turn approximately proportional to a particular substance concentration or other physical properties of the medium to be measured.

In order to standardise the measurements carried out, inline photometer devices are known which are equipped with a calibration instrument that comprises holding means, which are used to arrange a solid reference filter in the beam path. By means of such a calibration device, the inline photometer device can not only be calibrated but also validated, i.e. the performance capability of the inline photometer device can be checked particularly in respect of the maximal photometric accuracy, the wavelength accuracy or with respect to the scattered light component.

The accuracy of the absorption response of the solid reference filters employed, however, is not sufficiently high for some applications.

It is therefore an object of the invention to provide an inline photometer device and a calibration device as well as a corresponding calibration method, with which highly accurate validation and/or calibration is possible.

This object is achieved by an inline photometer device having the features of claim 1 and by a calibration device having the features of claim 2. Advantageous refinements of the invention are specified in the dependent claims. All combinations of at least two of the features disclosed in the description, the claims and/or the drawings also fall within the scope of the invention.

The invention is based on the concept of providing a reference part, which is filled or fillable with a reference liquid, instead of a solid reference filter. According to the validation or calibration process which is known per se, the reference part is generally removed from the one or more holding means of the calibration device, i.e. from the beam path of the inline photometer device, in order to be able to carry out inline measurements of the fluid in the measurement cell. For some applications, however, it may be expedient for the reference part filled with reference liquid to be left in the beam path during the inline measurement. The inline photometer device equipped with a calibration device as described can be validated or calibrated with high accuracy based on the use of a reference liquid which is definable exactly in respect of the absorption response, so that the measurement accuracies achievable with the inline photometer device can be substantially increased. The reference parts employed, which are filled or fillable with a reference liquid, may be used in all known inline photometer devices. Merely by way of example, interference filter photometers or spectral photometers will be mentioned. What is essential is that the reference part can be arranged in the beam path by means of the calibration device, preferably outside the measurement cell through which the fluid to the measured can flow. A light source for ultraviolet, visible and/or infrared light may be used as the light source for the inline photometer device according to the invention. In particular mercury, high-pressure, LED, halogen, deuterium, zinc or tungsten lamps may be used. It is furthermore conceivable to use lasers as the light source. Semiconductor detectors, in particular photodiodes, are preferably employed as photodetectors.

In one configuration of the invention, the reference part is advantageously a translucent cuvette that delimits a calibration volume which is filled or fillable with reference liquid. The cuvette is fitted into the one or more holding means of the calibration device so that it extends into the beam path between the light source and the photodetector.

As reference liquids, it is possible to employ liquids with highly accurate absorption response which are specially designed as a reference liquid, but also the process liquids with an absorption response accurately determined beforehand, for example by a laboratory spectrometer. Since the reference liquids employed are extremely cost-intensive—inter alia because of their highly accurate absorption response—, in one configuration of the invention the calibration volume is to be designed so that it is only as large as absolutely necessary. This is preferably achieved by shaping the cuvette so that the diameter of the calibration volume in the beam path direction, i.e. in the exposed direction, is less than in the horizontal and/or vertical direction.

It is particularly advantageous for the cuvette to be designed as a flat component, i.e. it preferably comprises two parallel side walls extending transversely to the beam path. These side walls delimit the calibration volume with their preferably flat inner surfaces, and they are preferably made of high-quality UV quartz glass. The glass should be free from bubbles (DIN 58927 class 0). The glass employed should furthermore be free from scratches, inclusions or particulate material (MIL-0-13830A)). Both surfaces of each of the side walls should be optically polished and have a roughness Rₐ=0.8 μm or better. It is furthermore advantageous for the transmissivities to be greater than 80% in a wavelength range between 254 nm and 1100 nm. The glass employed should furthermore preferably be fluorescence-free. In addition to the side walls extending perpendicularly to the beam direction, all other side walls of the cuvette are preferably made from a high-quality quartz glass. As an alternative to quartz glass, it is also possible to use sapphire or borosilicate glass or any other window suitable for the corresponding spectral range.

It is particularly advantageous for the cuvette to comprise two openings, which communicate with the calibration volume. By means of the openings, it is possible to fill the calibration volume with reference liquid, flush the calibration volume and/or extract the reference liquid from the calibration volume.

It is advantageous for the openings, preferably designed as channels, to be closable particularly by means of a closure cap in order to avoid contamination or other impairment of the high-accuracy reference fluid.

In order to prevent the reference liquid from emerging out of the cuvette, the openings are preferably arranged on the upper side of the cuvette.

So that it is possible to ensure residue-free flushing of the calibration volume, in one configuration of the invention it is advantageous for the calibration volume to comprise a curved contour at least in a lower region, i.e. overall it is preferably U-shaped. The U-shape allows efflux, in particular laminar efflux, of the entire reference fluid out of the cuvette.

It is particularly expedient to provide an opaque cover plate, preferably of black quartz glass, on the upper side of the cuvette in order to minimise extraneous light effects. The aforementioned openings for filling, flushing and/or emptying the cuvette are preferably formed in this cover plate.

It is advantageous to provide positioning means for exact positioning of the cuvette in the holding means, in order to ensure exact exposure of the cuvette, preferably exactly at a 90° angle. When the positioning means are provided with a bevel, this also makes it easier to find the holding position.

Further advantages, features and details of the invention will be found from the following description of preferred exemplary embodiments and with reference to the drawing, in which:

FIG. 1 shows a schematic representation of an inline photometer device with a calibration device,

FIG. 2 shows a side view of a reference part designed as a cuvette for insertion into the calibration device,

FIG. 3 shows the cuvette according to FIG. 2 in a view rotated through 90°,

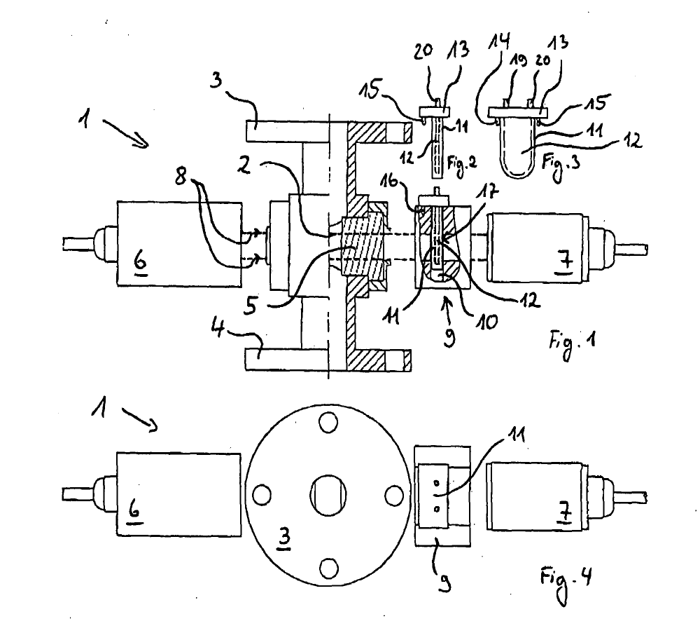

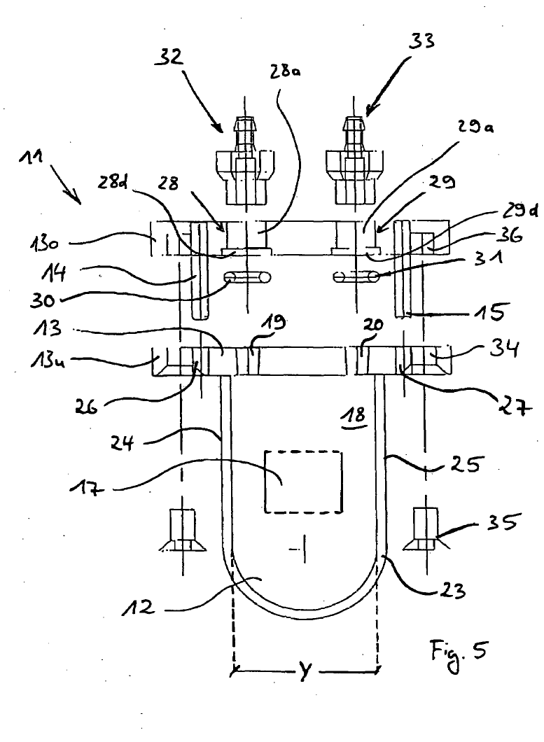

FIG. 4 shows a plan view of the inline photometer device according to FIG. 1,

FIG. 5 shows a side view of a cuvette,

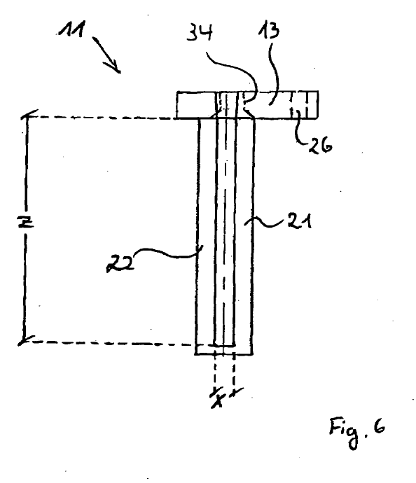

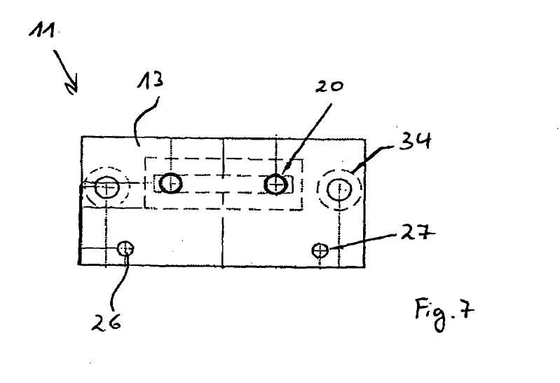

FIG. 6 shows a view rotated through 90° of the cuvette according to FIG. 5 and

FIG. 7 shows a plan view of the cuvette according to FIGS. 5 and 6.

In the figures, parts which are the same and parts which have the same function are denoted by the same references.

FIGS. 1 and 4 show an inline photometer device 1. The key component of the inline photometer device 1 is a tubular measurement cell 2 that can be integrated into a tube system by means of two mounting flanges 3, 4, which are spaced apart. The measurement cell 2 comprises two diametrically opposite quartz glass panes 5, of which only the quartz glass pane on the right in the plane of the drawing can be seen in the cutaway-represented half of the measurement cell 2.

A light source 6 designed as a tungsten lamp, which is represented as a black box, is arranged on the left of the measurement cell 2 in the plane of the drawing, an optical unit (not represented in further detail), particularly with focusing lens and/or polarising filters, being arranged in the black box in a manner known per se between the light source 6 and the measurement cell 2.

A photodetector 7 is arranged on the opposite side of the measurement cell 2 from the light source 6. The beam path 8 of the light generated by the light source 6 passes through the left-hand quartz glass pane (not shown) into the measurement cell, through which the fluid to be measured flows, and out of the measurement cell 2 on the opposite side through the quartz glass pane 5 then continues straight on to the photodetector 7, which measures the light intensity in the known way.

A calibration device 9, which comprises holding means 10 designed as a slot for receiving a reference part 11 designed as a flat cuvette, is arranged in the beam path 8.

The cuvette 11 is filled with a reference fluid 12, so that the inline photometer device can be calibrated and/or validated in a manner which is known per se.

As can be seen from FIGS. 2 and 3, the flat cuvette 11 contoured rectangularly in an upper region comprises an upper cover plate 13 made of an opaque black quartz glass. The cover plate 13 protrudes on all sides, so as to form a circumferential ledge via which the cuvette rests on the upper circumferential edge of the holding means 10 designed as a slot. Two alignment pins 14, 15, which can be inserted into the congruently shaped reception openings 16 in the calibration instrument 9 so that the cuvette 11 is exactly aligned, are provided on the cover plate 13.

As can be seen particularly from FIG. 1, a region 17 of the cuvette 11 protrudes into the beam path 8. After calibration, the cuvette 11 can be removed from the holding means 10 and therefore from the beam path 8. It is also possible to take out the entire calibration device 9.

The cuvette 11 schematically represented in FIGS. 1 to 3 is represented in detail in FIGS. 5 to 7. It can be seen in FIG. 5 that the cuvette is rounded in the lower region, so that it essentially has a U-shape. The cuvette 11 encloses a reception volume 18, which can be filled with reference liquid 12. The reception volume 18 may be filled with reference liquid via an opening 19, 20 designed as a channel, air present in the reception volume 18 being able to escape via the other respective opening 20, 19. The openings 19, 20 are formed in the aforementioned cover plate 13 made of black quartz glass.

The cover plate 13 may be formed by a lower plate 13u delimiting the reception volume 18 and a fastening plate 13o arranged on top. The lower plate 13u comprises the openings 19, 20 as well as bores 26, 27 for congruently shaped passage of the alignment pins 14, 15, whereas the fastening plate 13o is firmly connected to the alignment pins 14, 15. Flush with the openings 19, 20, the fastening plate 13o furthermore comprises through-openings 28, 29, each with a sealing section 28d, 29d facing the lower plate 13u in order to receive sealing rings 30, 31. The sealing rings 30, 31 may also advantageously be configured as sealing plates.

Above the sealing sections 28d, 29d, reception sections 28a, 29a for receiving connectors 32, 33 are arranged in such a way that they are shaped congruently with the two connectors 32, 33. The sealing rings 30, 31 seal the connectors 32, 33 and the openings 19, 20 from the surroundings on their opposite sides, so that the reference liquid 12 cannot escape from the channel formed by the connectors 32, 33 and openings 19, 20.

The connectors 32, 33 can be closed by covering caps (not represented in further detail). It is also conceivable not to provide openings for filling the reception volume 18. In such a case, the cuvette is prepackaged beforehand ready for use with a fully isolated reference liquid.

The diameter x of the calibration volume 18 in the direction of the beam path 8 is substantially less than the extent y in the horizontal direction and the extent z in the vertical direction. The calibration volume 18 is therefore minimal, so that it is possible to save considerable costs particularly in the consumption of the reference liquid 12. The calibration volume 18 is delimited by two parallel side walls made of translucent quartz glass, arranged transversely to the beam path 8, both opposing upper sides of each of the side walls 21, 22 being designed to be flat. In order to permit exact alignment of the cuvette 11 transversely to the beam path 8, the aforementioned alignment pins 14, 15 are provided.

That region 17 of the cuvette 11 which is exposed to the beam path 8 is marked by dashed lines in FIG. 5.

A circumferential wall 23 made of quartz glass, which connects the side walls 21, 22 together in the beam path direction, is arranged perpendicularly to the opposing side walls 21, 22. In other words, the calibration volume 18 is delimited by the parallel side walls 21, 22 and by the circumferential wall. The circumferential wall is rounded transversely to the beam path in a lower region of the cuvette, and in the upper region it merges into two parallel wall sections 24, 25.

### LIST OF REFERENCES

### Inline Photometer Device and Calibration Method

1 inline photometer device
2 measurement cell
3 mounting flange
4 mounting flange
5 quartz glass pane
6 light source
7 photodetector
8 beam path
9 calibration device
10 holding means
11 cuvette
12 reference fluid
13 cover plate
13u lower plate
13o fastening plate
14 alignment pin
15 alignment pin
16 reception openings
17 region
18 reception volume
19 opening
20 opening
21 side wall
22 side wall
23 circumferential wall
24 wall section
25 wall section
26 bore
27 bore
28 through-opening
28a reception section
28d sealing section
29 through-opening
29a reception section
29d sealing section
30 sealing ring
31 sealing ring
32 connector
33 connector
34 bore with chamfer
35 screw
36 threaded bore
x diameter in beam path direction
y extent in the horizontal direction
z extent in the vertical direction

1. Inline photometer device having a light source (6), a photodetector (7) placed at a distance therefrom, a measurement cell (2) which is arranged in the beam path (8) between the light source (6) and the photodetector (7) and through which a fluid to be measured can flow, and having a calibration device (9) for calibrating and/or validating the inline photometer device (1), the calibration device (9) comprising holding means (10) for arranging a reference part in the beam path, characterised in that the reference part (11) is filled or fillable with a reference fluid (12).

2. Device for calibrating an inline photometer device (1), having holding means (10) for arranging a reference part in the beam path (8) of the inline photometer device (1), characterised in that the reference part (11) is filled or fillable with a reference fluid (12).

3. Device according to claim 1 or 2, characterised in that the reference part (11) is a translucent cuvette delimiting a calibration volume (8).

4. Device according to one of the preceding claims, characterised in that at least in an exposed region (17) of the cuvette, the diameter (x) of the calibration volume (18) in the direction of the beam path (8) is less than in each direction (y, z) transverse thereto.

5. Device according to one of claims 3 and 4, characterised in that the cuvette (11) comprises two side walls (21, 22) arranged transversely to the beam path.

6. Device according to one of claims 3 to 5, characterised in that the cuvette (11) comprises two openings (19, 20).

7. Device according to claim 6, characterised in that the openings (19, 20) are closable.

8. Device according to claim 6 or 7, characterised in that the openings (19, 20) are arranged at a distance from one another on an upper side of the cuvette (11).

9. Device according to one of claims 3 to 8, characterised in that the calibration volume (18) comprises a curved, preferably U-shaped contour in a lower region.

10. Device according to one of claims 3 to 9, characterised in that an opaque cover plate (13) is arranged on the upper side of the cuvette (11).

11. Device according to one of claims 3 to 10, characterised in that the cuvette (11) comprises positioning means (14, 15) for exact positioning in the holding means (10).

12. Calibration method for the measurement of a fluid by an inline photometer device, having the following steps
determining the absorption response of a reference part filled with a reference fluid, particularly a cuvette, in a high-accuracy spectrometer, particularly a laboratory spectrometer,
inserting the reference part filled with reference fluid into the beam path of an inline photometer device, particularly outside a measurement cell through which the process fluid to be measured flows,
calibrating the inline photometer device with the previously determined absorption response of the reference part filled with reference fluid.

13. Calibration method according to claim 12, in which the process fluid is used as a reference fluid.
